(19) United States
(12) Patent Application Publication
(10) Pub. No.: US 2016/0352876 A1
(43) Pub. Date: Dec. 1, 2016

(54) Mobile Terminal

(71) Applicants: Yongli Chen, Shenzhen (CN); Meng Li, Shenzhen (CN)

(72) Inventors: Yongli Chen, Shenzhen (CN); Meng Li, Shenzhen (CN)

(73) Assignee: AAC Technologies Pte. Ltd., Singapore city (SG)

(21) Appl. No.: 15/004,973

(22) Filed: Jan. 24, 2016

(30) Foreign Application Priority Data
Jun. 1, 2015 (CN) 201520369313.4

(51) Int. Cl. H04M 1/02; H04B 5/02

(52) U.S. Cl. CPC H04M 1/026; H04B 5/02

(57) ABSTRACT

A mobile terminal is disclosed. The mobile terminal includes a metal back cover; an NFC coil located under the metal cover; a first slot set on the metal cover, the first slot including a plurality of slot cells set intervally along a same straight line, the slot cells dividing the metal back cover into a top and a body portion; and a second slot set on the top. A part of the NFC coil is located within a projection area of the top.

### FIELD OF THE INVENTION

The present disclosure relates to communication devices, and more particularly to a mobile terminal having an NFC (Near Filed Communication) antenna.

### DESCRIPTION OF RELATED ART

With the continuous development of cell phone, tablet PC, and other mobile terminal equipment, people's demand on the appearance of the mobile terminal equipment is higher and higher. The mobile terminal with a metal housing is loved by all consumers due to its texture and abrasion resistance.

The function of NFC(Near Filed Communication) of existing mobile terminal radiates signal through pasting NFC coil into the plastic back cover or tapping on the metal back cover and pasting NFC coil into the corresponding position of opening to radiate signal. But plastic back cover cannot meet development demand and radiation efficiency is lower.

Therefore, it is necessary to provide a new mobile terminal to overcome the problems mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an illustrative structure of a mobile terminal in accordance with a first embodiment of the present disclosure.

FIG. 2 is an illustrative structure of a mobile terminal in accordance with a second embodiment of the present disclosure.

FIG. 3 is an illustrative structure of a mobile terminal in accordance with a third embodiment of the present disclosure.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of present disclosure more apparent, the present disclosure is described in further detail together with the figures and the embodiments. It should be understood the specific embodiments described hereby is only to explain this disclosure, not intended to limit this disclosure.

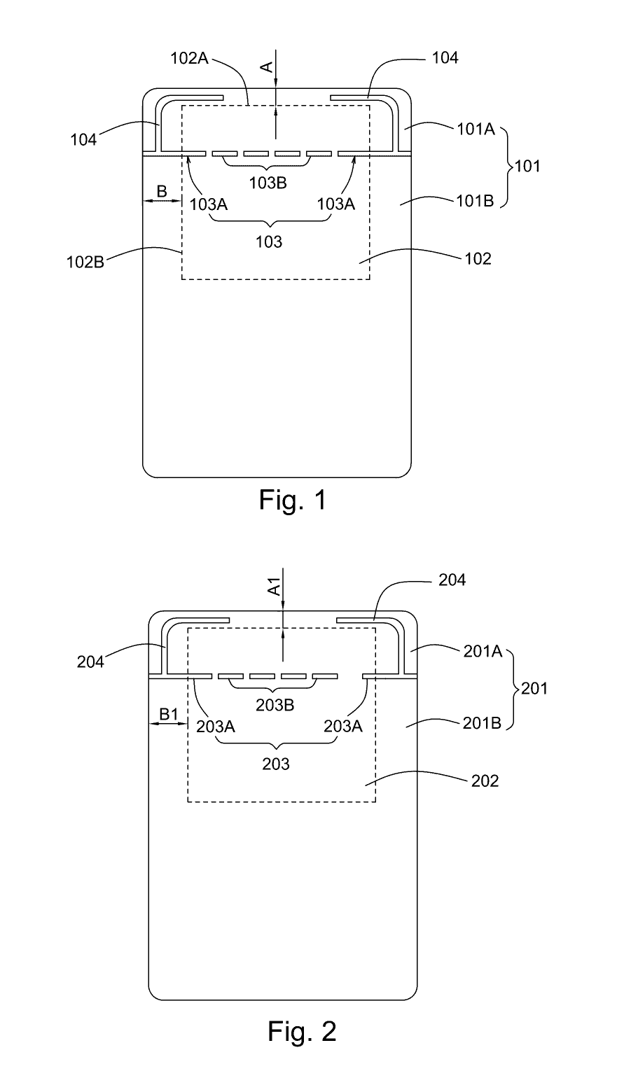

FIG. 1 is an illustrative structure of a mobile terminal in accordance with a first embodiment of the present disclosure. The mobile terminal includes a metal back cover 100 and an NFC (Near Field Communication) coil 102 located under a metal back cover 101. The NFC coil 102 is the dotted part in FIG. 1. A first slot 103 is set on the metal back cover 100. The first slot 103 includes a plurality of slot cells which are set intervally and at the same straight line. The slot cells divide the metal back cover 100 into a top 101A and a body portion 101B that are connected partially. One part of the NFC coil 102 is located in a projection area of the top 101A, i.e., the first slot 103 passes through a projection area of the NFC coil 102.

Slot cell includes two longer slots 103A set on two sides of the body portion 101B and four shorter slots 103B set between two longer slots 103A. Two longer slots 103A and four shorter slots 103B are on the same straight line. A distance between every two adjacent shorter slots 103B is equal, i.e., the four shorter slots 101B are set evenly and intervally between two shorter slots 103B. Two longer slots 103A extend to a side edge of the body portion 101B.

Two second slots 104 are provided on two sides of the top 101A respectively. One end of two the second slots 104 is connected with the two longer slots 103A.

The top 101A has a top edge away from the first slot 103. The body portion 101B has a side edge. The NFC coil 102 has a first side edge 102A close to the edge of top 101A and a side edge close to body portion 101B, the second side edge 102B connected with the first side edge 102A. A distance A between the first side edge 102A and the first slot 103 is 8 mm. A distance B between the second side edge 102B and the side edge is 12 mm. Distance A and distance B are not set randomly, which can further improve the radiation performance of the NFC coil.

The first slot 103 and the second slot 104 set on the top cover 101B can promote the radiation efficiency of the NFC coil 102 and let NFC coil play its function better under the environment of metal backing.

FIG. 2 is an illustrative structure of a mobile terminal in accordance with a second embodiment of present disclosure. The terminal includes a metal back cover 201 and an NFC coil 202 located under the metal back cover 201. The NFC coil 202 is the dotted box part in FIG. 2. A first slot 203 is set on the metal back cover 200. The first slot 203 includes a plurality of slot cells that are set intervally and at the same straight line. These slot cells divide the metal back cover 200 into a top 201A and a body portion 201B that are connected partially. One part of the NFC coil 202 is located in a projection area of the top 201A, i.e., the first slot 203 passes through a projection area of the NFC coil.

The slot cell includes two longer slots 203A set on two sides of the body part 201B respectively and four shorter slots 203B set between two longer slots 203A. A distance of each adjacent two shorter slots 201B is equal. What is different from the previous embodiment is that the distance between the first longer slot 203B and the adjacent longer slot 203A is shorter than the distance between the fourth shorter slot 203B and the adjacent longer slot 203B. Two longer slots 203A extend to side edge of body portion 201B.

There are two second slots 204 set respectively on two ends of the top 201A respectively, and one end of two second slots 204 is connected with two longer slots 203A.

The top 201A has a top edge away from the first slot 203. The body part 201B has a side edge. The coil 202 has a first side edge 202A close to the top 201A and the side edge close to the body part 201B, the second side edge 202B connected with the first side edge 202A. A distance A1 between the first side edge 202A and the first slot 203 is 10 mm. A distance B1 between the second side edge 202B and the side edge is 12 mm.

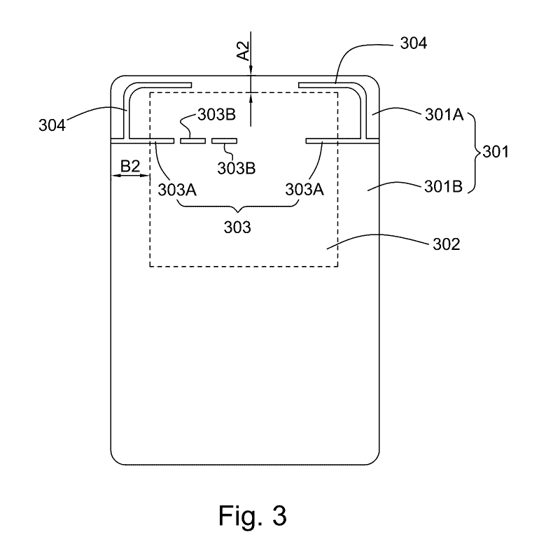

FIG. 3 is an illustrative structure of a mobile terminal in accordance with a third embodiment of the present disclosure. The mobile terminal includes a metal back cover 301 and an NFC coil 302 located under the metal back cover 301. The NFC coil 302 is the dotted box part in FIG. 3. The first slot 301 is set on a metal back cover 300.The first slot 301 includes several slot cells that are set intervally and the same straight line. Slot cell divides the top 301A and a body part 301B that are connected partially. One part of the NFC coil 302 is located in the area orthographically projected by top 301A, namely the first slot 301 passes through orthographically projected by the NFC coil 302.

Slot cell includes two longer slots 303A set on two sides of the body part 301B and two shorter slots 303B set between two longer slots 303A. Spacing between each two adjacent shorter slots 301B is equal. The difference from the previous embodiment is that the distance between the first longer slot 303B and the adjacent longer slot 303A should be shorter than the distance between the fourth shorter slot 303B and adjacent longer slot 303B. Two longer slots 303A extend to the side edge of the body part 301B.

There are two second slots 304 set respectively on two ends of the top 301A. One end of two the second slot 304 is connected with two longer slots 303A.

The top 301A has a top edge away from the first slot 301. The body part 301B has a side edge. The NFC coil 302 has a first side edge 302A close to edge of the top 301A and the side edge close to the body part 301B and a second side edge 302B connected with the first side edge 302A. The distance A2 between the first side edge 302A and the first slot 301 is 10 mm. The distance B2 between the second side edge 302B and the side edge is 12 mm.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mobile terminal, comprising:
a metal back cover;
an NFC coil located under the metal cover;
a first slot set on the metal cover, the first slot including a plurality of slot cells set intervally along a same straight line, the slot cells dividing the metal back cover into a top and a body portion;
a second slot set on the top; wherein
a part of the NFC coil is located within a projection area of the top.

2. The mobile terminal according to claim 1, wherein the slot cell includes a longer slot set on both sides of the body portion and a shorter slot set intervally between two said longer slots.

3. The mobile terminal according to claim 2, wherein distances between any two adjacent shorter slots is equal.

4. The mobile terminal according to claim 2, wherein four shorter slots are provided evenly and intervally between two longer slots.

5. The mobile terminal according to claim 2, wherein two shorter slots are provided.

6. The mobile terminal according to claim 4, wherein a distance between one of the shorter slot and the adjacent longer slot is shorter than a distance between another one shorter slot and adjacent longer slot.

7. The mobile terminal according to claim 6, wherein one end of the two longer slots extend respectively to an edge of the body portion.

8. The mobile terminal according to claim 7, wherein the second slot is set intervally on two sides of the top and the second slot is connected with the longer slot.

9. The mobile terminal according to claim 8, wherein the top is away from the top edge of the first slot, the body portion has a side edge, the NFC coil has a first side edge closed to the top edge and a second side edge that is close to the side edge and connected with the first side edge, a distance between the first side edge and the first slot is 8-10 mm, and a distance between the second side edge and the side edge is 8-23 mm.
